(19) United States
(12) Patent Application Publication
(10) Pub. No.: US 2006/0212440 A1
(43) Pub. Date: Sep. 21, 2006

(54) Program translation method and program translation apparatus

(75) Inventors: Taketo Heishi, Osaka (JP); Tomoo Hamada, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd, Osaka (JP)

(21) Appl. No.: 11/370,859

(22) Filed: Mar. 9, 2006

(30) Foreign Application Priority Data
Mar. 16, 2005 (JP) 2005-075916

(51) Int. Cl. G06F 17/30

(52) U.S. Cl. 707/4

(57) ABSTRACT

In a development of system software, a compiler system and the like are included in a program development system for increasing performance efficiency of an overall computer system and reducing manpower necessary for developing system software. The compiler system is a program for reading a source program and system level hint information and translating them into a machine language program, generating the machine language program and outputting task information that is information relating to the program. The system level hint information is a collection of information that become hints for optimization performed in the compiler system, and is made up of an analysis result obtained by a profiler, an instruction from a programmer, task information relating to the source program and task information relating to another source program that is different from the source program.

### BACKGROUND OF THE INVENTION

(1) Field of the Invention

The present invention relates to a program translation method and a program translation apparatus for translating a source program written in a high-level language such as C language into a machine language program, and in particular to an information input to a compiler and an optimization performed in the compiler.

(2) Description of the Related Art

Conventionally, various types of compilers which translate a source program written in a high-level language into a machine-language instruction sequence have been proposed. However, a simple compiler cannot prevent a deterioration of performance due to, for example, a miss in a cache memory and the like. Consequently, in recent years, there has been proposed a compiler which realizes an optimization for reducing misses in a cache memory based on information in the source program and profile information of the source program (e.g. refer to Japanese Laid-Open Patent Applications No. 2001-166948 and No. 7-129410).

However, in the conventional technology, optimization processing is executed only focusing on a system's own task. The influences from other tasks in the system are thus still not taken into consideration. Therefore, there is a problem in that performance of an overall computer system is greatly deteriorated due to a cache miss and the like in a cache memory in the case where plural tasks are operated in time division on a unit processor or in the case where plural tasks are operated on plural processors which have respective local cache memories. Such problem of performance deterioration in a greater range is found not only in the compiler but also in an Operating System (OS) and a hardware scheduler when they perform task scheduling depending on a result of the task scheduling.

Therefore, a programmer of a system software needs to manually and exploratory perform data placement and the like such that a large amount of manpower is required for development.

### SUMMARY OF THE INVENTION

In order to overcome the aforementioned problem, an object of the present invention is to provide a program translation method and the like by which, in system software development, execution performance of an overall computer system is improved and the manpower required for system software development can be reduced.

In order to achieve the aforementioned object, a program translation method according to the present invention is a program translation method for translating a source program written in a high-level language into a machine language program, the method including: performing lexical analysis and syntactic analysis on the source program; translating the source program into intermediate codes based on results of the lexical and syntactic analyses; receiving hint information for increasing an efficiency of executing the machine language program; optimizing the intermediate codes based on the hint information; and translating the optimized intermediate codes into a machine language program, wherein the hint information includes information relating to at least one subject to be executed other than a subject to be executed which is associated with the source program to be translated.

Accordingly, the optimization can be performed at a system level considering information relating to at least one subject to be executed other than a subject to be executed that is a subject to be translated, that is, information relating to a task or thread other than a task or a thread to be translated. Therefore, in system software development, there can be provided a program translation method by which an execution performance for an overall computer system is improved and the manpower required for system software development is reduced.

Also the optimizing may include adjusting, based on the hint information, the pieces of data to be optimized so that a cache memory is effectively used.

Accordingly, the data placement can be determined considering the information relating to the task or thread other than the task or the thread to be translated in order to prevent the pieces of data from being mapped focusing on a particular set of a cache memory and causing thrashing. The present invention thus contributes to improve performance as an overall computer system and to facilitate an improvement of system software development.

Further, the said optimizing may include allocating, based on the hint information, the subject to be executed which is a subject to be translated to one of processors in which the subject is to be executed.

Accordingly, the determinations of data placement and processor allocation can be performed so as to increase the use efficiency of a local cache memory in the multi-processor system considering the information relating to the task or thread other than a task to be translated. The present invention thus contributes to improve performance as an overall computer system and to facilitate an improvement of system software development.

Further, each step included in such program translation method is applicable to a loader which loads the machine language program into a main memory.

Also, a program development system according to another aspect of the present invention is a program development system for developing a machine language program from a source program, the system including: a compiler system; a simulation apparatus which executes the machine language program generated by the compiler system and outputs an execution log; and a profiling apparatus which analyzes the execution log outputted by the simulation apparatus and outputs an execution analysis result for an optimization to be performed in the compiler system. The compiler system is a compiler system for developing a machine language program from a source program, the system including: a first program translation apparatus which translates a source program written in a high-level language into a first machine language program; and a second program translation apparatus which receives at least one object file and translates the received object file into a second machine language program. The first program translation apparatus includes: a parser unit which performs lexical analysis and syntactic analysis on the source program; an intermediate code translation unit which translates the source program into intermediate codes based on results of the lexical and syntactic analyses; a first hint information receiving unit which receives first hint information for increasing an efficiency of executing the first machine language program; a first optimization unit which optimizes the intermediate codes based on the first hint information; and a first machine language program translation unit which translates the intermediate codes optimized by the first optimization unit into a first machine language program, wherein the first hint information includes information relating to at least one subject to be executed other than a subject to be executed which is associated with the source program to be translated. The second program translation apparatus includes: a second hint information receiving unit which receives second hint information for increasing an efficiency of executing the second machine language program; a second optimization unit which translates, based on the second hint information, the optimized object file into the second language program while optimizing the object file, wherein the second hint information includes information relating to at least one subject to be executed other than a subject to be executed which is associated with the at least one object file to be translated.

Accordingly, the result of analyzing the execution of the machine language program generated by the compiler system can be fed back to the compiler system again. Also, with respect to the result of executing the task or thread other than the task or thread to be translated, the result of analyzing the execution can be fed back to the compiler system. The present invention, therefore, contributes to improve performance as an overall computer system and facilitate software development.

It should be noted that the present invention is not only realized as a program translation method having such characteristic steps but also as a program translation apparatus having the characteristic steps included in the program translation method as units, and as a program for causing a computer to execute the characteristic steps included in the program translation method. Further, it is obvious that such program can be distributed using a recording medium such as a Compact Disc-Read Only Memory (CD-ROM) or via a communication network such as the Internet.

Compared to the conventional compiling means, the present invention can be optimized at a system level including influences of other files, tasks and threads so that the execution performance of the computer system is improved.

In addition, there is no longer necessary for the programmer of system software to exploratory perform data placements and the like so that the manpower required for software system development is reduced.

As further information about technical background to this application, the disclosure of Japanese Patent Application No. 2005-075916 filed on Mar. 16, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a hardware structure of a system that is a target of a compiler system according to a first embodiment of the present invention;

FIG. 2 is a block diagram showing a hardware structure of a cache memory;

FIG. 3 is a diagram showing a detailed bit configuration of a cache entry;

FIG. 4 is a block diagram showing a structure of a program development system for developing a machine language program;

FIG. 5 is a functional block diagram showing a structure of the compiler system;

FIG. 6 is a diagram for explaining an outline of processing performed by a placement set information setting unit and a data placement determination unit;

FIG. 7 is a flowchart showing details of processing performed by a cache line adjustment unit;

FIG. 8 is a diagram showing an example of alignment information;

FIG. 9 is a diagram showing an image of a loop reconfiguration performed by the cache line adjustment unit;

FIG. 10 is a flowchart showing details of processing performed by a placement set information setting unit;

FIG. 11 is a diagram showing an example of placement set information;

FIG. 12 is a diagram showing an example of an actual placement address of a piece of significant data;

FIG. 13 is a diagram showing an example of set placement status data;

FIG. 14 is a flowchart showing details of processing performed by the data placement determination unit;

FIG. 15 is a block diagram showing a hardware structure of a system that is a target of a compiler system according to a second embodiment of the present invention;

FIG. 16 is a functional block diagram showing a structure of the compiler system;

FIG. 17 is a flowchart showing details of processing performed by a processor number hint information setting unit;

FIG. 18 is a diagram showing an example of processor allocation status data;

FIG. 19 is a flowchart showing details of processing performed by a placement set information setting unit;

FIG. 20 is a flowchart showing details of processing performed by a processor number information setting unit;

FIG. 21 is a flowchart showing details of processing performed by a data placement determination unit;

FIG. 22 is a diagram showing an example of system level hint information; and

FIG. 23 is a diagram showing a structure of applying the present invention to a loader.

### DESCRIPTION OF THE PREFERRED EMBODIMENTS

A compiler system according to embodiments of the present invention is described hereinafter with reference to the drawings.

### First Embodiment

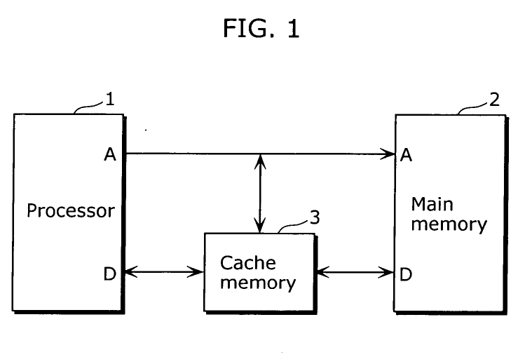

FIG. 1 is a block diagram showing a hardware structure of a computer system that is a target of a compiler system according to a first embodiment of the present invention. The computer system includes a processor 1, a main memory 2 and a cache memory 3.

The processor 1 is a processing unit which executes a machine language program.

The main memory 2 is a memory for storing a machine language instruction, various types of data and the like executed by the processor 1.

The cache memory 3 is a memory which operates in accordance with a four-way set-associative method and can read/write data faster than the main memory 2. It should be noted that a storage capacity of the cache memory 3 is smaller than that of the main memory 2.

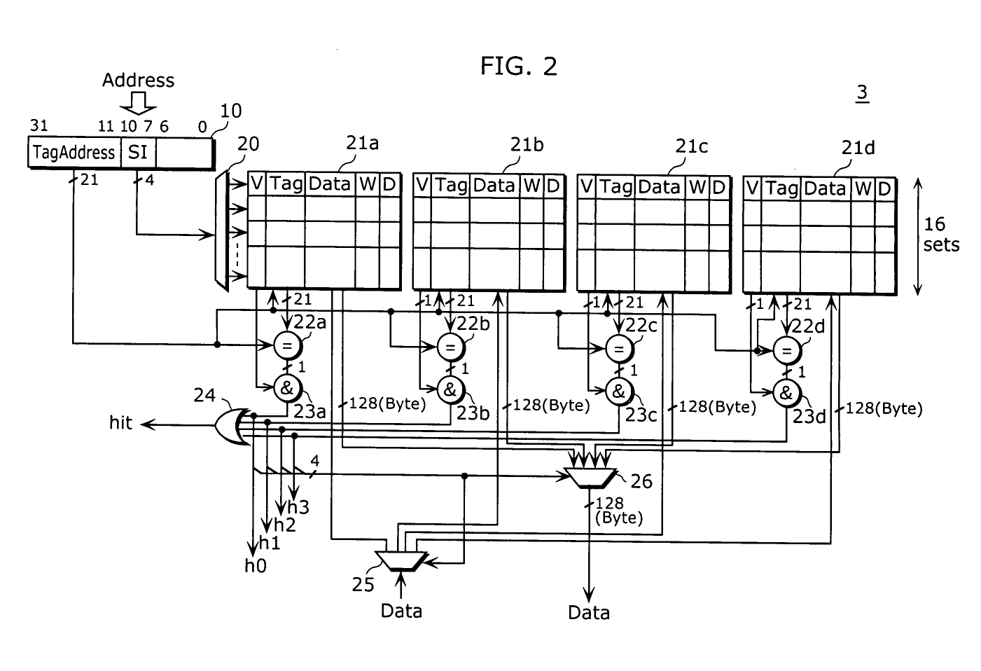

FIG. 2 is a block diagram showing a hardware structure of the cache memory 3. As shown in the diagram, the cache memory 3 is a cache memory of four-way set-associative method, and includes an address register 10, a decoder 20, four ways 21a to 21d (hereafter respectively abbreviated to as “ways 0 to 3”), four comparators 22a to 22d, four AND circuits 23a to 23d, an OR circuit 24, a selector 25 and a demultiplexer 26.

The address register 10 is a register which holds an access address to the main memory 2. This access address is assumed to be 32 bits. As shown in the diagram, the access address includes a 21-bit tag address and a 4-bit set index (SI in the diagram) sequentially from the most significant bit. Here, the tag address indicates a region in the main memory 2 to be mapped to ways. The set index (SI) indicates one of sets crossing over the ways 0 to 3. Since the set index (SI) is 4 bits, there are 16 sets. A block specified by the tag address and set index (SI) is a unit of replacement, and is called as line data or a line in the case where the block has been stored in the cache memory 3. The size of line data is 128 bytes that is a size determined by an address bit (7 bits) that is lower than the set index (SI). If one word is defined as 4 bytes, one line data has 32 words. Seven bits from the lowest address bit of the address register 10 are ignored when a way is accessed.

The decoder 20 decodes 4-bit data of the set index (SI) and selects one out of 16 sets crossing over the four ways 0 to 3.

The four ways 0 to 3 respectively have the same structure and a memory of the total of 4×2 K bytes. The way 0 includes 16 cache entries.

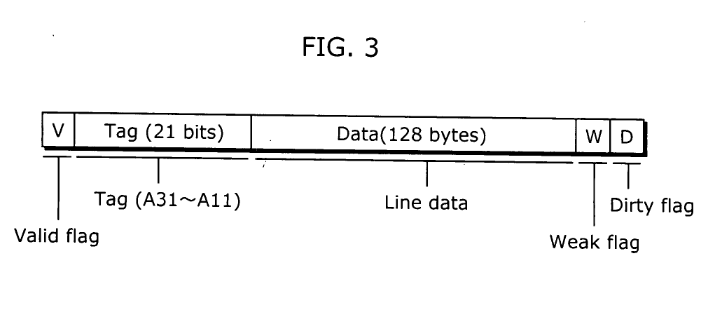

FIG. 3 shows a detailed bit configuration of one cache entry. As shown in the diagram, one cache entry holds a valid flag V, a 21-bit tag, 128-byte line data, a weak flag W and a dirty flag D. The “valid flag V” indicates whether or not the cache entry is valid. The “tag” is a copy of a 21-bit tag address. The “line data” is a copy of 128-byte data in a block specified by the tag address and the set index (SI). The “dirty flag D” is a flag which indicates whether or not the cache entry has been written, that is, whether or not a write-back to the main memory 2 is necessary since the data cached in the cache entry is different from data in the main memory 2 due to the writing. The “weak flag W” is a flag which indicates data to be expelled from the cache entry. In the case where there is a cache miss, data is preferentially expelled from the cache entry whose weak flag W is 1.

The bit configuration of the way 0 is similarly applied to the ways 1 to 3. Four cache entries crossing over the four ways to be selected via the decoder 20 by 4 bits of the set index (SI) are called as a “set”.

The comparator 22a compares whether or not the tag address in the address register 10 matches a tag of the way 0 from among the four tags included in the set selected by the set index (SI). The same structure as the comparator 22a applies to the comparators 22b to 22c except they respectively correspond to ways 21b to 21d.

The AND circuit 23a compares whether or not the valid flag V matches a comparison result obtained by the comparator 22a. This comparison result is referred to as h0. It indicates that, when the comparison result h0 is 1, there is line data corresponding to the tag address and set index (SI) in the address register 10, that is, there is a hit in the way 0. Also, when the comparison result h0 is 0, it indicates that there is a miss hit. The same structure as the AND circuit 23a applies to the AND circuits 23b to 23d except they respectively correspond to ways 21b to 21d. The comparison results h1 to h3 indicate whether there is a hit or a miss hit in the ways 1 to 3.

The OR circuit 24 calculates a logical OR of the comparison results h0 to h3. The value “hit” showing this logical OR indicates whether or not there is a hit in the cache memory 3.

The selector 25 selects a piece of line data of a hit way from among respective pieces of line data of the ways 0 to 3 in the selected set.

The demultiplexer 26 outputs writing data to one of the ways 0 to 3 when writing data into the cache entry.

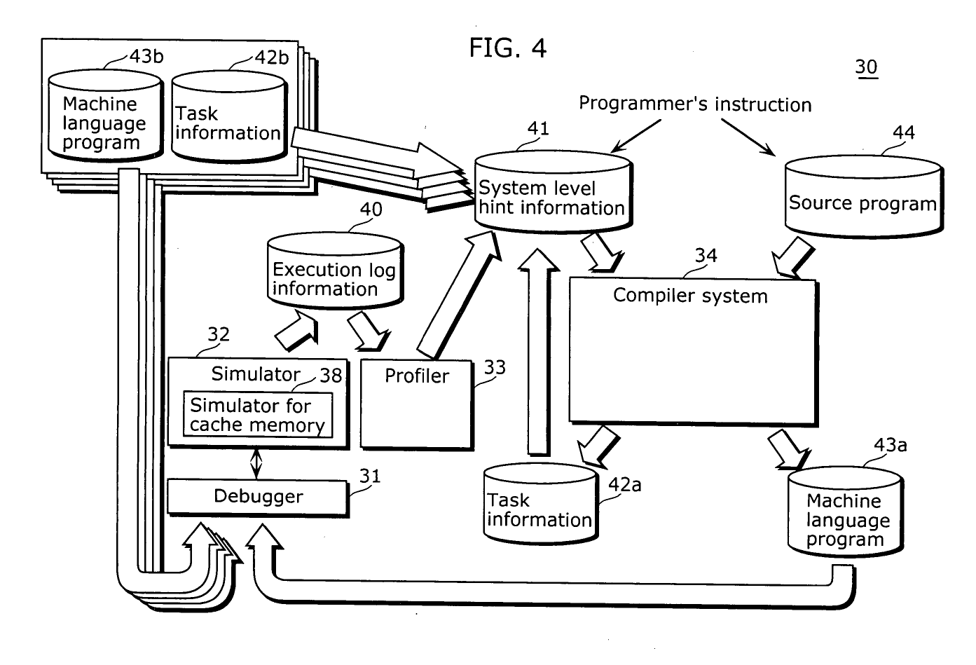

FIG. 4 is a block diagram showing a structure of a program development system 30 for developing a machine language program executed by the processor 1 of the computer system shown in FIG. 1. The program development system 30 includes a debugger 31, a simulator 32, a profiler 33 and a compiler system 34. Each constituent of the program development system 30 is realized as a program executed on a computer (not shown in the diagram).

The compiler system 34 is a program for reading a source program 44 and system level hint information 41 and translating them into a machine language program 43a. The compiler system 34 generates the machine language program 43a and outputs task information 42a that is information relating to the program. The details about the compiler system 34 are described later.

The debugger 31 is a program for specifying a location and a cause of a bug found when the source program 44 is compiled in the compiler system 34 and for checking an execution status of the program.

The simulator 32 is a program for virtually executing the machine language program and outputs information at the time of execution as execution log information 40. Note that, the simulator 32 has a simulator 38 for cache memory which outputs the execution log information 40 by containing, in the execution log information 40, the simulation result such as hit and miss hit in the cache memory 3.

The profiler 33 is a program for analyzing the execution log information 40 and outputting, to system level hint information 41, information that becomes a hint for an optimization and the like performed in the compiler system 34.

The system level hint information 41 is a collection of information that become hints for an optimization performed in the compiler system 34, and includes the analysis result obtained by the profiler 33, an instruction (e.g. a pragma, a compilation option, and a built-in function) to the compiler system 41 by a programmer, the task information 42a relating to the source program 44, and the task information 42b relating to a source program that is different from the source program 44.

In the present software development system 30, plural tasks executed in the computer system can be analyzed as information using the debugger 31, the simulator 32 and the profiler 33, and the information relating to the plural tasks executed in the computer system can be inputted to the compiler system 34 as the system level hint information 41. Further, the compiler system 34 itself outputs, in addition to the machine language program 43a, the task information 42a relating to a task to be compiled that becomes a portion of the system level information 41.

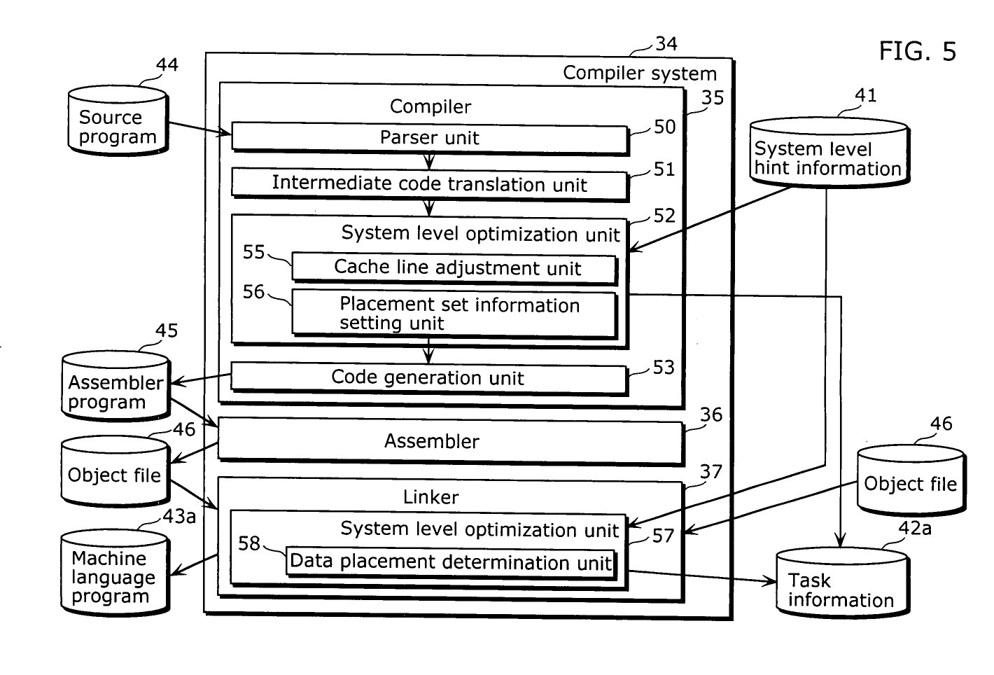

FIG. 5 is a functional block diagram showing a structure of the compiler system 34. This compiler system is a cross compiler system for translating the source program 44 written in a high-level language such as C language and C++ language into the machine language program 43a which is targeted for the processor 1. It is realized as a program executed in a computer such as a personal computer, and mainly includes a compiler 35, an assembler 36 and a linker 37.

The compiler 35 includes a parser unit 50, an intermediate code translation unit 51, a system level optimization unit 52, and a code generation unit 53.

The parser unit 50 is a processing unit which extracts a reserved word (key word) and the like for the source program 44 to be compiled, and performs lexical and syntactic analysis on it.

The intermediate code translation unit 51 is a processing unit which translates each statement of the source program 44 sent from the parser unit 50 into an intermediate code based on a predetermined rule.

The system level optimization unit 52 is a processing unit which performs, on the intermediate code outputted from the intermediate code translation unit 51, processing such as redundancy reduction, instruction rearrangement, and register allocation so as to realize an increase of execution speed and a reduction of code size and the like. It includes a cache line adjustment unit 55 and a placement set information setting unit 56 that perform optimization specific to the present compiler 35 based on the inputted system level hint information 41, in addition to a common optimization processing. The processing performed by the cache line adjustment unit 55 and the placement set information setting unit 56 is described later. It should be noted that the system level optimization unit 52 outputs, as task information 42a, information such as information relating to data placement which becomes a hint for compiling another source program or for re-compiling the current source program.

The code generation unit 53 generates an assembler program 45 by replacing all codes to machine language instructions with reference to an internally held translation table and the like for the intermediate code outputted from the system level optimization unit 52.

The assembler 36 generates an object file 46 by replacing all codes to machine language codes in a binary format with reference to an internally held translation table and the like for the assembler program 45 outputted from the compiler 35.

The linker 37 generates a machine language program 43a by determining a placement of addresses and the like of unresolved pieces of data and connecting them to plural object files 46 outputted from the assembler 36. The linker 37 includes a system level optimization unit 57 which performs optimization specific to the present linker 37 based on the inputted system level hint information 41 and the like in addition to common connection processing. The system level optimization unit 57 includes a data placement determination unit 58. The processing performed by the data placement determination unit 58 is described later. It should be noted that the linker 37 outputs, to the task information 42a, information such as information relating to data placement which becomes a hint for compiling another source program and for re-compiling the source program, together with the machine language program 43a.

The compiler system 34 is particularly aimed for reducing cache misses in the cache memory 3. The cache misses are divided mainly into the following three: 1) a compulsory miss; 2) a capacity miss; and 3) a conflict miss.

The “compulsory miss” indicates a miss hit caused because, in the case where an object (data or instruction stored in the main memory 2) is accessed for the first time, the object has not been stored in the cache memory 3. The “capacity miss” indicates a miss hit caused because the large number of objects are tried to be processed at once so that a large number of objects cannot be stored in the cache memory 3. The “conflict miss” indicates a miss hit caused because different objects try to use a cache entry in the cache memory 3 at the same time so that they try to expel each another from the cache entry. The compiler system 34 practices a resolution for the “conflict miss” which causes serious performance deterioration at the system level.

Next, a characteristic operation of the compiler system 34 configured as described above is explained with reference to a specific example.

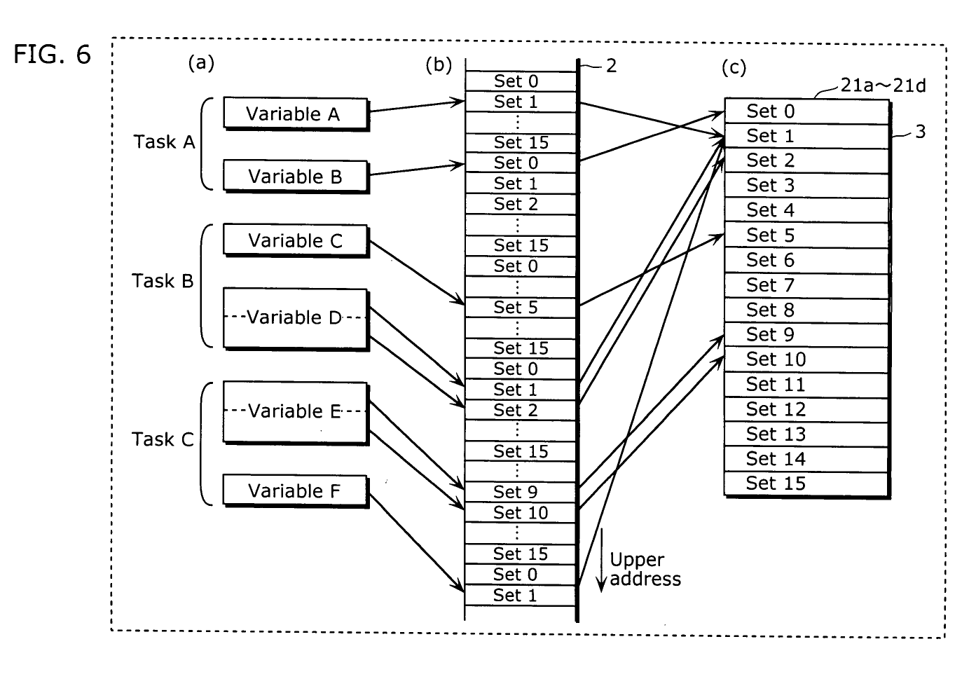

FIG. 6 is a diagram for explaining an outline of optimization processing relating to data placement by the placement set information setting unit 56 and the data placement determination unit 58. FIG. 6(a) indicates variables (variables A to F) that are frequently accessed in each task or in each file. Here, in order to simplify the explanation, the data size of each variable is determined as the size of line data in the cache memory 3, that is, a multiple of 128 bytes. In the compiler system 34, respective placement addresses and sets of the variables are determined so that these variables are not mapped concentrating on the same set in the cache memory 3 causing thrashing. In the example shown in FIG. 6, pieces of significant data (a variable A of a task A, a variable D of a task B, and a variable F of a task C) in the computer system have been mapped concentrating on the same set 1 in the cache memory 3 as shown in FIG. 6(c). Therefore, there is a possibility of causing thrashing. Accordingly, optimization is aimed for avoiding such situation. The details about each optimization processing in the compiler system 34 are explained hereinafter.

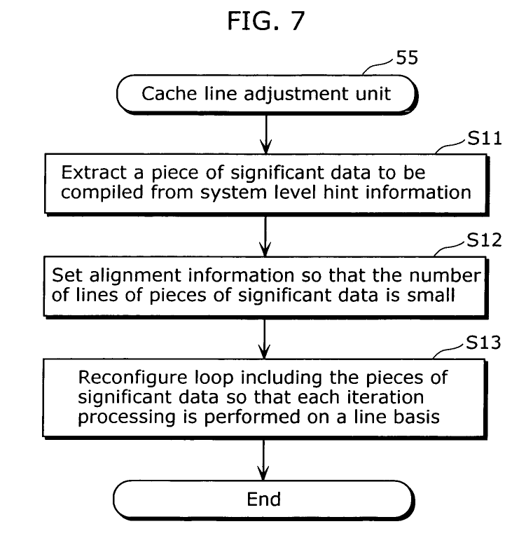

FIG. 7 is a flowchart showing processing details performed by the cache line adjustment unit 55 of the system level optimization unit 52 in the compiler 35.

The cache line adjustment unit 55 is a unit of performing each adjustment processing so that later optimization processing is effectively operated. It firstly extracts pieces of significant data whose placements to be compiled should be considered, based on the system level hint information 41 (Step S11). Actually, it extracts pieces of data causing thrashing instructed by the profiler 33 or a user or frequently accessed pieces of data. While the specific example of the system level hint information 41 is described later, the pieces of data included in the system level hint information 41 are treated as the “significant data”.

Next, the cache line adjustment unit 55 sets alignment information to the pieces of data extracted in Step S11 so as to reduce the number of lines occupied by the pieces of data (Step S12). The linker 37 determines final placement addresses of the pieces of data adhering to the align information so that the number of occupied lines adjusted here is kept.

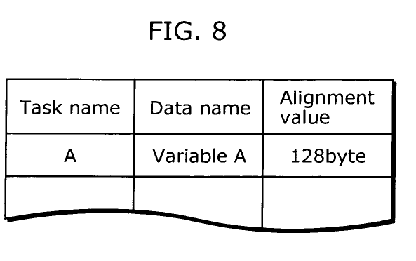

FIG. 8 is a diagram showing an example of the alignment information. For example, the variable A that is a piece of data of the task A indicates a piece of data to be placed by aligning in a unit of 128 bytes.

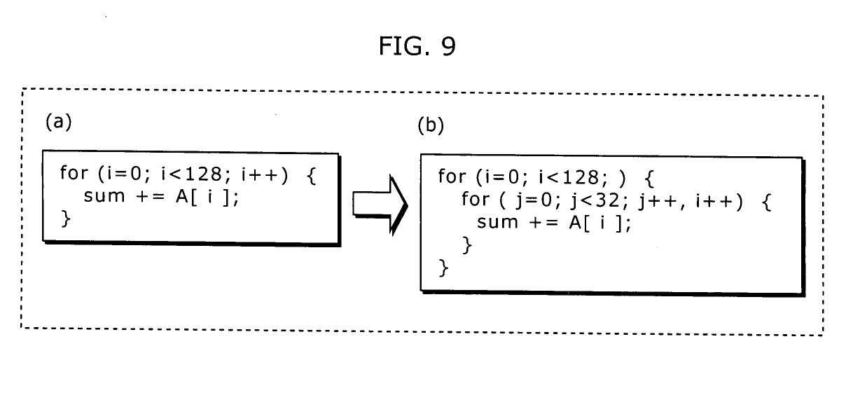

The cache line adjustment unit 55 lastly reconfigures a loop including the extracted pieces of data so that each iteration processing is performed on a line-by-line basis when necessary (Step S13). Specifically, for a loop in which an amount of significant pieces of data to be processed exceeds the amount of three lines, the iterations in the loop are divided and the loop is reconfigured so as to have a double loop structure having an inner loop for processing a piece of data of one line and an outer loop for repeatedly processing on the inner loop. FIG. 9 shows a specific translation image. In the alignment information shown in FIG. 8, the variable A (sequence A) should be aligned for each 128 bytes (one line size) so that a structural translation to the double loop is performed. This processing is performed to prevent, in the case where the loop processing is divided into plural threads, a use efficiency of the cache memory from decreasing since data for each thread crosses over line boundaries. In specific, the loop processing of processing data A (sequence A) for four lines (equals to 4×128 bytes) as shown in FIG. 9(a) is aligned for each one line (equals to 128 bytes) and structurally translated into loop processing of processing a piece of data for one line.

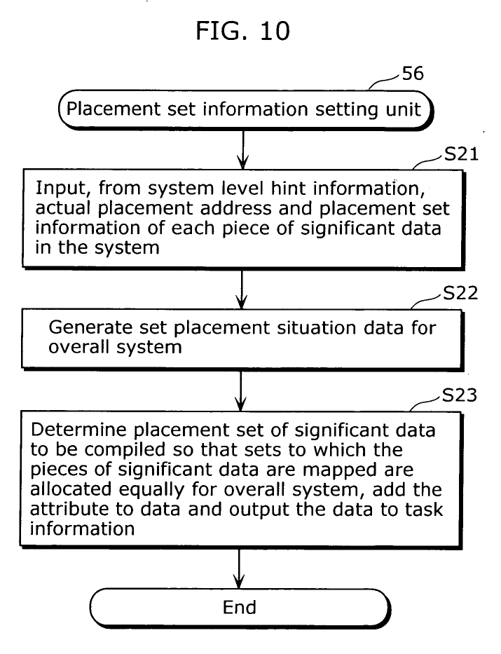

FIG. 10 is a flowchart showing details of processing performed by the placement set information setting unit 56 of the system level optimization unit 52 in the compiler 35.

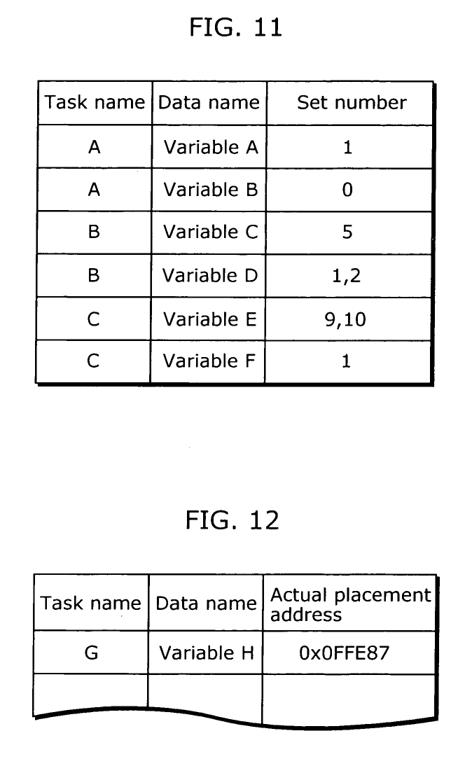

The placement set information setting unit 56 inputs, firstly from the system level hint information 41, an actual placement address and placement set information of each piece of significant data including at least one task other than the task to be compiled (Step S21). FIG. 11 is a diagram showing an example of placement set information generated based on the data placement shown in FIG. 6, and each piece of information includes a “task name”, “a data name” and “a set number”. For example, it is indicated that the variable A of the task A is placed at the set number A in the cache memory 3. FIG. 12 is a diagram showing an example of an actual placement address of a piece of the significant data, and each address includes a “task name”, a “data name” and an “actual placement address” in the main memory 2. For example, it is indicated that the variable H of the task name G is placed at an address of 0xFFE87 in the main memory 2.

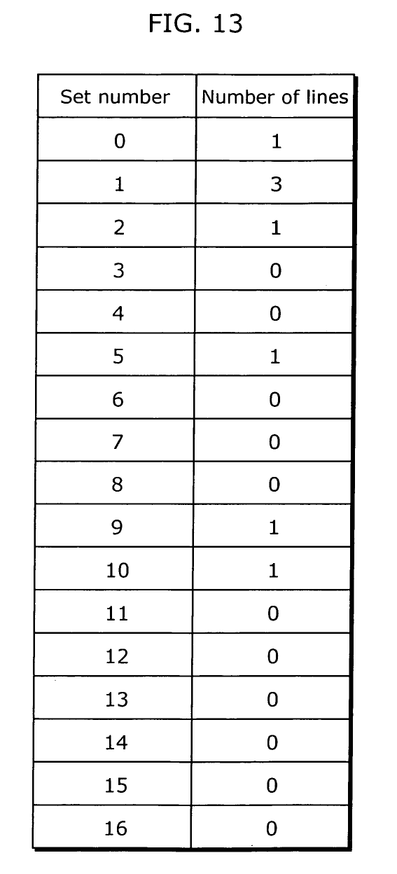

Next, the placement set information setting unit 56 obtains a set to be placed in the cache memory 3 for the pieces of data to which the actual placement addresses are inputted in Step S21, and generates set placement status data for an overall system (Step S22). This set placement status data indicates, for each set in the cache memory, how many lines of the pieces of significant data in the system are mapped. FIG. 13 is a diagram showing an example of the set placement status data generated based on the data placement shown in FIG. 6. The set placement status data shows a “set number” and “the number of lines” of the pieces of data to be mapped to the set corresponding to the set number. For example, it is indicated that a piece of data for one line is mapped to the set 0 and pieces of data for three lines are mapped to the set 1.

Lastly, the placement set information setting unit 56 determines, for the overall computer system, a placement set of the pieces of significant data to be compiled extracted by the cache line adjustment unit 55 so that the pieces of significant data are mapped equally to respective sets without causing deviation, and outputs the information also to the task information 42a while adding the attribute to the pieces of data (Step S23). The task information 42a is referred when a data placement of other pieces of data to be compiled is determined. Also, the attribute added to the pieces of data is referred when task scheduling is performed by an OS and the like.

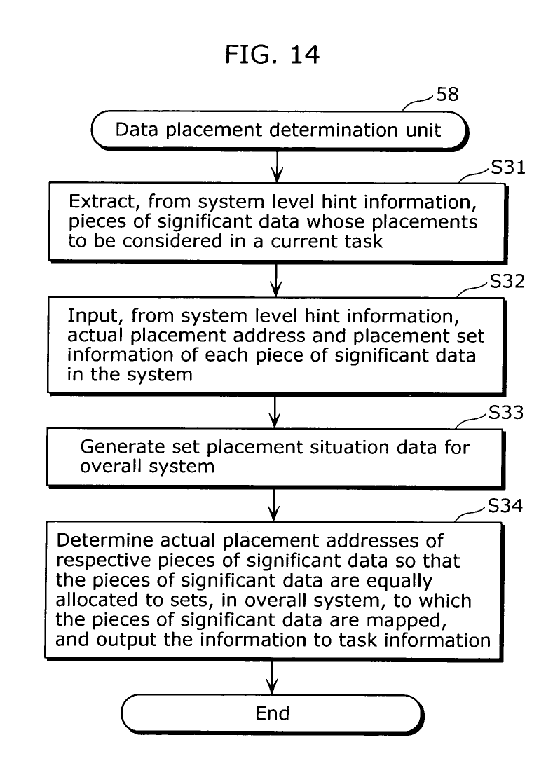

FIG. 14 is a flowchart showing details of processing performed by the data placement determination unit 58 of the system level optimization unit 57 in the linker 37.

The data placement determination unit 58 extracts, firstly from the system level hint information 41, pieces of significant data whose placements to be considered in a target task (Step S31). It actually extracts pieces of data causing thrashing instructed by one of the profiler 33 and the user or pieces of frequently accessed data. This processing is same as the processing of Step S11.

The data placement determination unit 58 further inputs, from the system level hint information 41, an actual placement address and placement set information for each piece of significant data including tasks other than the task to be compiled (Step S32). This processing is same as the processing in Step S21.

Next, the data placement determination unit 58 obtains, from the actual placement address inputted in Step S32 and the actual placement address of the object file 46 inputted to the linker 37, a set of the cache memory 3 into which each piece of data is placed, and generates set placement status data for the overall computer system (Step S33). This set placement status data indicates how many lines of pieces of significant data in the system are mapped to each set in the cache memory. The set placement status data is same as the one shown in FIG. 13.

Lastly, the data placement determination unit 58 determines actual placement addresses of pieces of significant data in the current task extracted in Step S31 so that the pieces of significant data are mapped equally to the sets without causing deviation for the overall computer system, and outputs the information also to the task information 42a (Step S34). This task information 42a is referred when a data placement of other tasks to be compiled is determined. In other words, as in the case of the set 1 of the set placement status data shown in FIG. 13, when pieces of data are mapped in concentration, actual placement addresses are re-determined by re-mapping the pieces of data to the smallest number of lines (e.g. set 3 or set 4) and the like.

As described above, in the compiler system 34, information as hint information including information of tasks other than the task to be compiled is inputted and a data placement is determined so that the equal number of the pieces of significant data is mapped to the sets of the cache memory. Therefore, the compiler system 34 can prevent a deterioration of performance due to thrashing.

### Second Embodiment

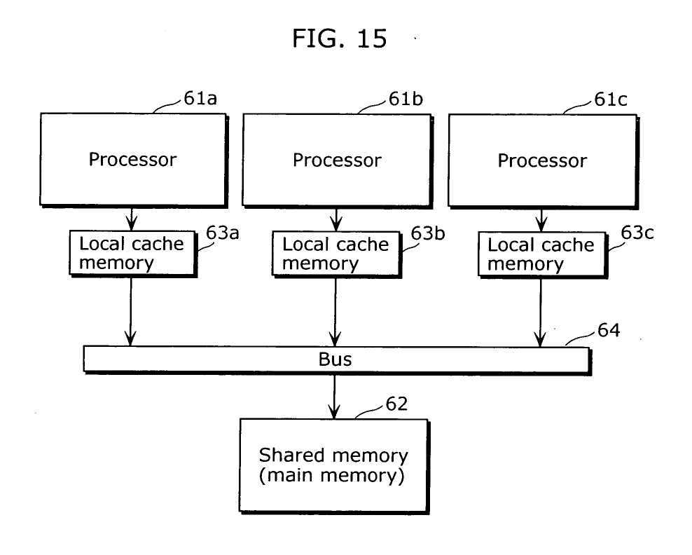

FIG. 15 is a block diagram showing a hardware structure of a computer system that is a target of a compiler system according to the second embodiment of the present invention. The computer system includes three processors (61a to 61c), local cache memories (63a to 63c) of the respective processors, and a shared memory 62. The three processors having the respective local cache memories are connected to the shared memory 62 via the bus 64.

Respective operations of the processors 61a to 61c are same as those described in the first embodiment, and the operation of the shared memory 62 is same as that of the main memory 2 described in the first embodiment. Each program or thread in the computer system is scheduled by the operating system so as to be executed in parallel by the processors 61a to 61c. The hint information for the task scheduling by the operating system can be embedded into the machine language program as a compiler system. In specific, information indicating one of the following information is attached as hint information: a desired one of processors to which each task and thread should be allocated; and a desired one of tasks and threads that should be allocated to a same processor.

Each of the local cache memories 63a to 63c has a function for maintaining data consistency, in addition to the function of the cache memory 3 described in the first embodiment of holding contents of the main memory 2 and allowing a high-speed data access. This is a function for preventing miss-operations caused by which the plural local cache memories 63a to 63c respectively hold a piece of data of the same address of the shared memory 62 and independently perform updating processing on the data. In specific, the local cache memories 63a to 63c respectively have a function of monitoring the statuses of the bus 64 and other local cache memories 63a to 63c. In the case where a piece of data of the same address as the piece of data held in one local cache memory is updated in another one of the local cache memories 63a to 63c, the data consistency is maintained by revoking the piece of data held in own local cache memory.

While the data consistency can be maintained with this system, frequent data revocations cause great deterioration in view of performance. Accordingly, considering this problem in the program development system, the improvement of use efficiency of the cache memories 63a to 63c is encouraged.

The structure of the program development system is same as the structure of the program development system 30 shown in FIG. 4 of the first embodiment. However, the program development system of the present embodiment uses a compiler system 74 described hereinafter in place of the compiler system 34.

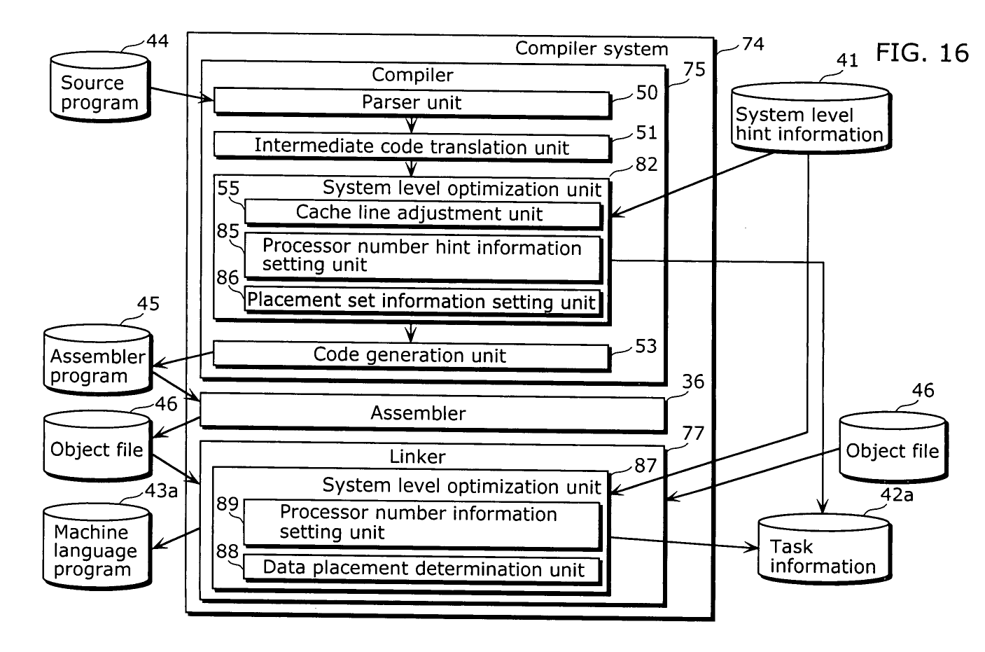

FIG. 16 is a functional block diagram showing a structure of the compiler system 74 in the program development system. Most of the constituents are same as described in the block diagram of the compiler system 34 shown in FIG. 5 in the first embodiment. Therefore, different constituents are only described hereinafter.

The compiler system 74 adopts a compiler 75 in place of the compiler 35 in the compiler system 34 and a linker 77 in place of the linker 37.

The compiler 75 adopts a system level optimization unit 82 in place of the system level optimization unit 52 of the compiler 35. Compared to the system level optimization unit 52, the system level optimization unit 82 adds a processor number hint information setting unit 86, and adopts a placement set information setting unit 86 in place of the placement set information setting unit 56. The operation of the cache line adjustment unit 55 is same as described in the first embodiment.

The linker 77 adopts a system level optimization unit 77 in place of the system level optimization unit 57 of the linker 37. Compared to the system level optimization unit 57, the system level optimization unit 77 adds a processor number information setting unit 89, and adopts a data placement determination unit 88 in place of the data placement determination unit 58.

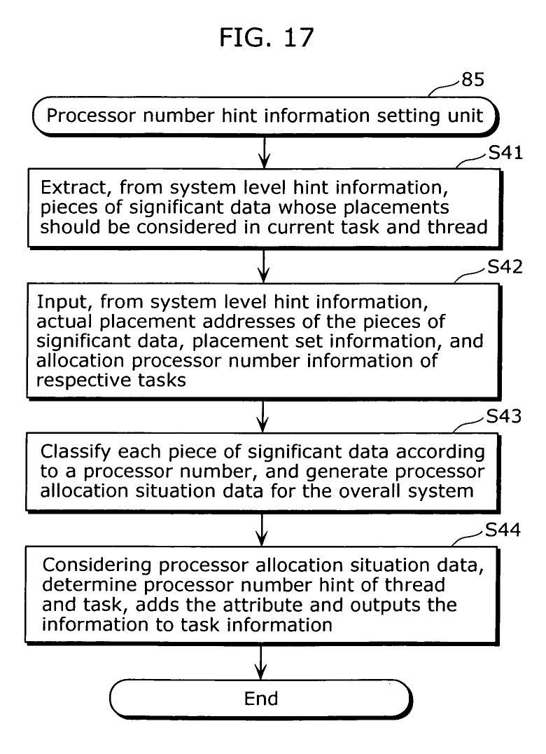

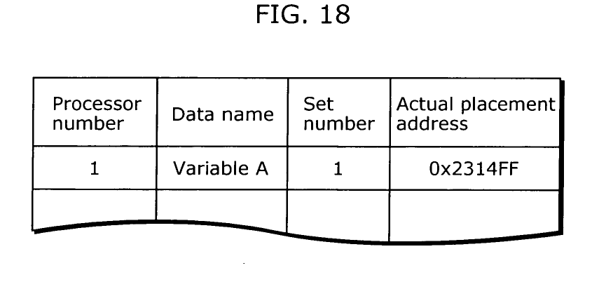

FIG. 17 is a flowchart showing proceeding details performed by a processor number hint information setting unit 85.

The processor number hint information setting unit 85 firstly extracts, based on the system level hint information 41, pieces of significant data whose data placements should be considered in threads and tasks (Step S41). Actually, it extracts pieces of data which generate thrashing specified by one of the profiler 33 and the user, or pieces of frequently accessed data.

The processor number hint information setting unit 85 further inputs, from the system level hint information 41, an actual placement address and placement set information of each piece of significant data including at least one task other than the task to be compiled and processor number information of each task (Step S42).

The processor number hint information setting unit 85 then classifies each piece of significant data according to each processor number, and generates processor allocation status data for an overall system (Step S43). The processor allocation status data indicates, for each processor, a piece of significant data with an address and a set that are instructed to be allocated to each processor. For example, it is the data shown in FIG. 18.

The processor number hint information setting unit 85 lastly determines, considering the processor allocation status data, for a thread and a task to which each piece of data extracted in Step S41 belongs, a processor number hint of the thread and task, adds the attribute so that pieces of data having the same address are to be allocated to the same processor and that pieces of data are to be mapped equally to the same set of the same processor, and outputs the information also to the task information 42a (Step S44). This task information 42a is referred to when a data placement and a processor number are determined when other pieces of data are compiled.

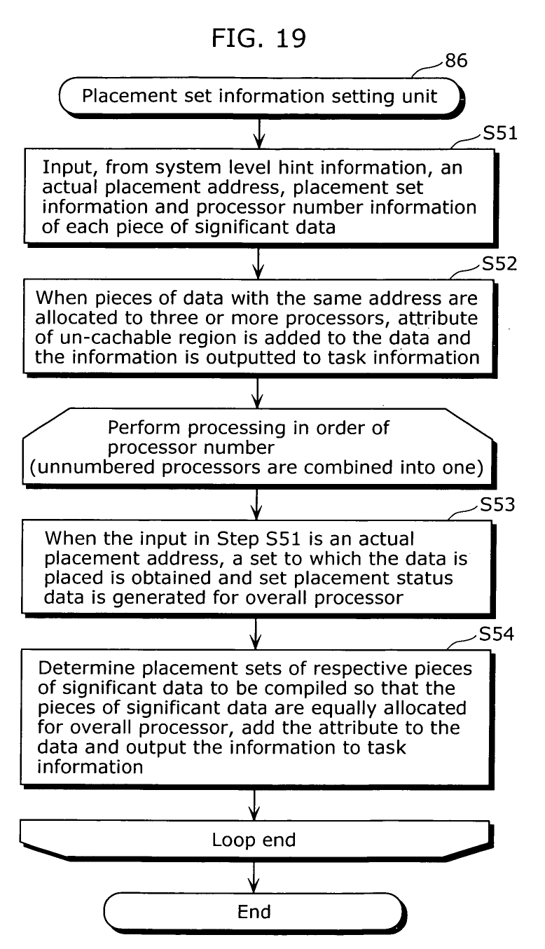

FIG. 19 is a flowchart showing processing details performed by the placement set information setting unit 86.

The placement set information setting unit 86 firstly inputs, from the system level hint information 41, an actual placement address, placement set information and processor number information of each piece of significant data including at least one task other than the task to be compiled (Step S51).

The placement set information setting unit 86 then checks, for the pieces of significant data of the thread and task extracted by the processor number hint information setting unit 85, whether or not pieces of data having the same address are allocated to three or more processors, adds, when the above checking result is positive, an attribute of uncachable region to the data, and outputs the information also to the task information 42a (Step S52). The “uncachable region” is a region in the shared memory 62a in which pieces of data in the region are not transferred to the local cache memories 63a to 63c. The processing in Step S52 is performed for preventing performance deterioration by the overhead processing for maintaining data consistency that is necessary when the pieces of significant data are copied to many local cache memories.

The processing described hereinafter is executed in order of the processor numbers. Note that, a piece of data to which a processor number is not assigned is treated as a piece of data to be assigned to one processor, and the processing is executed. In specific, in the case where the information inputted in Step S51 is an actual placement address, the placement set information setting unit 86 obtains a set in the local cache memory into which the piece of data to be placed into a region with the address is placed, and generates set placement status data for the overall processor (Step S53). This set placement status data indicates how many lines of pieces of significant data in the processor are mapped to each set in the cache memory. In other words, it is same as the data shown in FIG. 13.

The placement set information setting unit 86 lastly determines a placement set of pieces of significant data among pieces of data to be compiled extracted by the processor number hint information setting unit 85, so that the pieces of significant data are equally mapped to sets in view of the overall processor, adds the attribute to the data, and outputs the information also to the task information 42a (Step S54). This task information 42a is referred to when a data placement and a processor number are determined when pieces of data are compiled on other compiling unit basis.

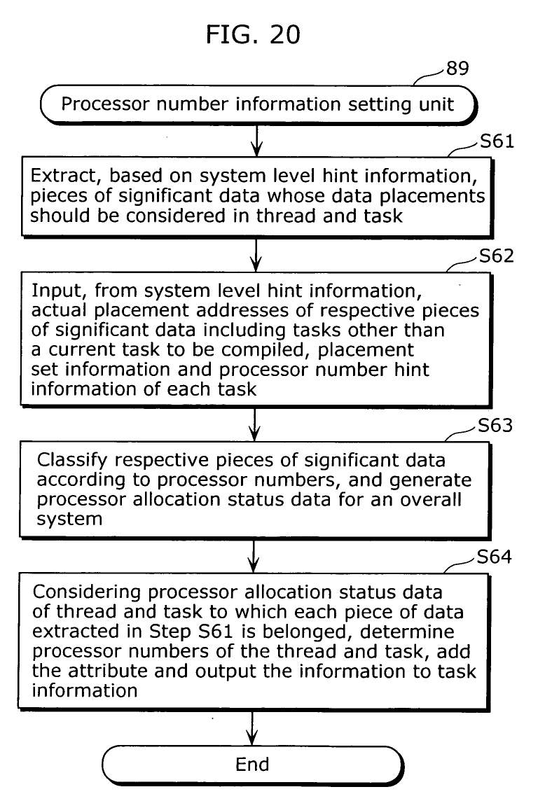

FIG. 20 is a flowchart showing processing details of the processor number information setting unit 89.

The processor number information setting unit 89 firstly extracts, based on the system level hint information 41, pieces of significant data whose data placements in the thread and task should be considered (Step S61). Actually, it extracts pieces of data which generate thrashing specified by one of the profiler 33 and the user, or pieces of frequently accessed data.

The processor number information setting unit 89 further inputs, from the system level hint information 41, an actual placement address and placement set information of each piece of significant data including tasks other than the task to be compiled and processor number hint information of each task (Step S62).

The processor number information setting unit 89 then classifies each piece of significant data according to the processor number, and generates processor allocation status data for the overall system (Step S63). This processor allocation status data indicates an instruction of allocating, to each processor, a piece of significant data having an address and a set. For example, it is the data shown in FIG. 18.

The processor number information setting unit 89 lastly determines, considering the processor allocation status data, for a thread and a task to which each piece of data extracted in Step S61 belongs, a processor number of the thread and task and adds the attribute so that pieces of data having the same address are allocated to the same processor and that pieces of data are equally mapped to the same set of the same processor, and outputs the information also to the task information 42a (Step S64). This task information 42a is referred to when a data placement and a processor number are determined in the case where pieces of data are compiled on other compiling unit basis. Also, an OS or a hardware scheduler can allocate a task to a processor and performs task scheduling by referring to the attribution information attached to the task.

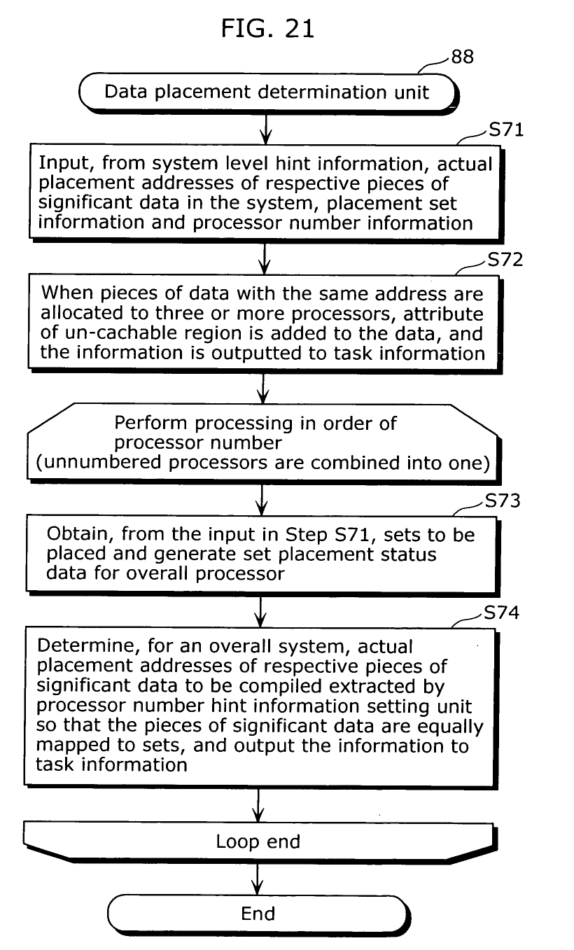

FIG. 21 is a flowchart showing processing details performed by the data placement determination unit 88.

The data placement determination unit 88 firstly inputs, from the system level hint information 41, an actual placement address and placement set information of each piece of significant data including at least one task other than a task to be compiled and processor number information (Step S71).

The data placement determination unit 88 then checks, for the pieces of significant data of the tread and task extracted by the processor number information setting unit 89, whether or not the pieces of data having the same address are allocated to three or more processors, adds the attribute of uncachable region to the pieces of data when the above checking result is positive, and outputs the information also to the task information 42a (Step S72). This processing is performed in order to prevent a performance deterioration caused by an overhead for maintaining data consistency that is necessary when the pieces of significant data are copied to many local cache memories.

The following processing is executed according to processor numbers. Note that, the pieces of data to which respective processor numbers are not assigned are treated as being allocated to one processor, and processing is executed. The data placement determination unit 88 obtains sets placed respectively from the actual placement address inputted in Step S71 and the actual placement address of the inputted object file, and generates set placement status data for the overall processor (Step S73). This set placement status data is data indicating how many lines of the pieces of significant data in the processor are mapped to each set of a cache memory.

The data placement determination unit 88 lastly determines actual placement addresses of the pieces of significant data to be compiled extracted by the processor number information setting unit 89 so that the pieces of significant data are equally mapped to the sets in view of the overall processor, and outputs the information also to the task information 42a (Step S74). This task information 42a is referred to when the data placement and the processor number are determined when other pieces of data are compiled.

As described above, in the compiler system 74, information including information of at least one task other than the task to be compiled is inputted as hint information, and a data placement is determined by the plural processors so as not to distribute the same piece of data to local cache memories of respective processors and to equally map the pieces of data to respective sets of the local cache memories. Therefore, the compiler system 74 prevents performance deterioration due to thrashing.

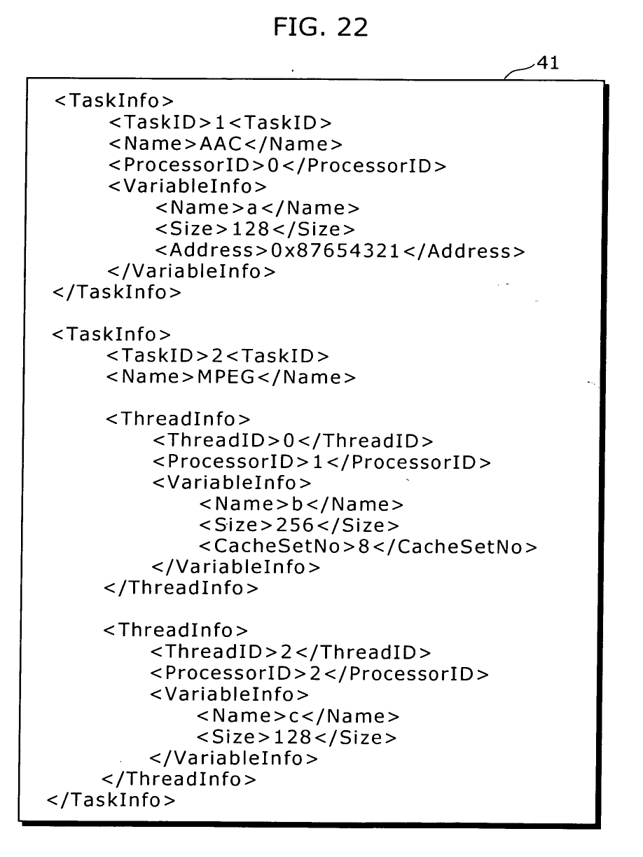

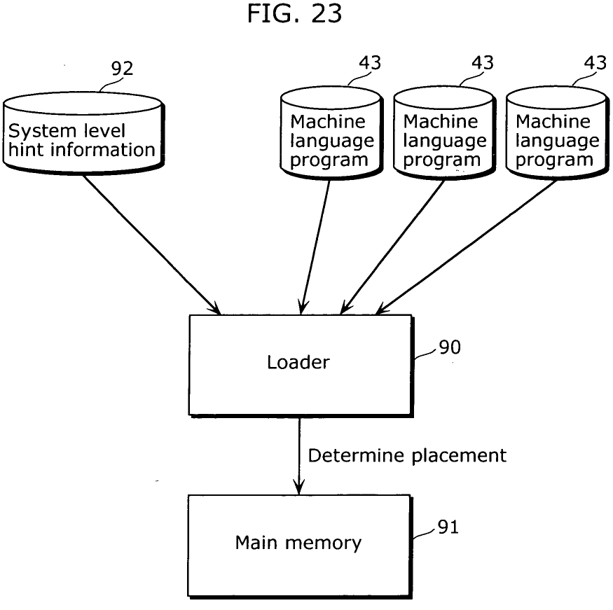

As complementarily explanation, FIG. 22 shows an example of a system level hint information file inputted to the compiler system according to the aforementioned present embodiment.

As shown in FIG. 22, for each task in the system and a thread included in each task, a name of a piece of significant data and an address and a set number thereof if specified can be designated together with the allocated processor ID at the point in time, as information for determining a data placement and a processor number in the compiler system. For example, a portion surrounded by <TaskInfo> and </TaskInfo> indicates task information for one task, and a portion surrounded by <ThreadInfo> and </ThreadInfo> indicates thread information for one thread. In addition, a portion surrounded by <VariableInfo> and </VariableInfo> corresponds to one piece of the aforementioned significant data, and information such as actual address information and processor number are included therein.

As shown in the block diagram of the program development system in FIG. 4, this hint information includes information which is automatically generated from the profiler 33, information which is automatically generated from the compiler system and information described by the programmer.

While the program development method and compiler system according to the present invention are described in the above based on the embodiments, the present invention is not only limited to the embodiments described above. The specific examples are as follow.

1) While, in the present embodiment, it is assumed that the system level hint information is inputted in a form of a file, the effect of the present invention can be realized not only limited to the case of file input, but also to a method of designating as a compiling option, a method of additionally writing a pragma instruction in a source file, or to a method of writing a built-in function showing instruction details in the source file.

2) While, in the present embodiment, it is assumed to perform optimization statically in the compiler system, the system of the present invention can be installed in a loader 90 which loads a program and data into a memory as shown in FIG. 23. In this case, the loader 90 reads each machine language program 43 and system level hint information 92, adds processor number hint information, determines placement addresses of the pieces of significant data, and allocates the pieces of data in the main memory 91 based on the determined placement addresses. With such structure, the effect of the present invention can be realized.

3) While, in the present embodiment, a compiler system for a single processor described in the first embodiment and a compiler system for multi-processors described in the second embodiment are separately described, they are not necessarily to be separated. One compiler system is adaptable to both of the single processor and the multi-processors. This case can be realized by providing, to a compiler system, information relating to a processor to be compiled in a form of a compiling option or of hint information.

4) While, in the second embodiment, shared memory type multi-processors are targeted, the present invention is not limited to the structure of the multi-processors and cache memories. The significance of the present invention is maintained even in the multiprocessor system having a structure such as a distributed shared memory type having no concentric shared memory.

5) While, in the second embodiment, it is assumed that an OS schedules a task and a thread to each processor based on the processor number hint information, the presence of OS is not necessary. The effect of the present invention can be realized even in a system having a scheduler which executes scheduling in hardware in place of OS.

6) While a multiprocessor system with actual processors is assumed in the second embodiment, the processors do not need to be the actual processors. For example, significance of the present invention can be maintained even in a system for causing a single processor to operate in time-division and as virtual multi-processors, or in a multi-processor system having plural multi-processors.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applicable to a compiler system, and in particular to a compiler system which targets a system for executing plural tasks.

What is claimed is:

1. A program translation method for translating a source program written in a high-level language into a machine language program, said method comprising:
performing lexical analysis and syntactic analysis on the source program;
translating the source program into intermediate codes based on results of the lexical and syntactic analyses;
receiving hint information for increasing an efficiency of executing the machine language program;
optimizing the intermediate codes based on the hint information; and
translating the optimized intermediate codes into a machine language program,
wherein the hint information includes information relating to at least one subject to be executed other than a subject to be executed which is associated with the source program to be translated.

2. The program translation method according to claim 1,
wherein the hint information includes information indicating pieces of data to be optimized including the at least one subject to be executed other than the subject to be executed which is associated with the source program to be translated, and
said optimizing includes adjusting, based on the hint information, the pieces of data to be optimized so that a cache memory is effectively used.

3. The program translation method according to claim 1,
wherein said optimizing includes adjusting, based on the hint information, the pieces of data to be optimized so that a cache memory is effectively used, and
said adjusting includes adjusting a data placement so as to reduce the number of lines in a cache memory occupied by the pieces of data to be optimized.

4. The program translation method according to claim 1,
wherein said optimizing includes adjusting, based on the hint information, the pieces of data to be optimized so that a cache memory is effectively used, and
said adjusting includes dividing a loop including the pieces of data to be optimized so that the pieces of data are accessed on a line-by-line basis of a cache memory in each iteration of the loop.

5. The program translation method according to claim 1,
wherein the hint information includes information relating to actual placement addresses of respective pieces of data to be optimized, the pieces of data including the at least one subject to be executed other than the subject to be executed which is associated with the source program to be translated, and
said optimizing includes setting, based on the hint information, information relating to a set into which the pieces of data to be optimized are placed.

6. The program translation method according to claim 1,
wherein the hint information includes information indicating one of sets in a cache memory into which the pieces of data to be optimized are placed, the pieces of data including the at least one subject to be executed other than the subject to be executed which is associated with the source program to be translated, and
said optimizing includes setting, based on the hint information, information relating to the set into which the pieces of data to be optimized are placed.

7. The program translation method according to claim 1,
wherein said optimizing includes setting, based on the hint information, information relating to a set into which the pieces of data to be optimized are placed, and
said setting includes determining, based on the hint information, one of sets in the cache memory into which the pieces of data to be optimized are placed, in order to prevent the pieces of data specified by the hint information from being placed in a same set in the cache memory and causing thrashing.

8. The program translation method according to claim 1,
wherein said optimizing includes setting, based on the hint information, information relating to a set into which the pieces of data to be optimized are placed, and
said setting includes determining, based on the hint information, placements of pieces of data included in a subject to be executed which is a subject to be translated so that the equal number of pieces of data are mapped to respective sets in the cache memory.

9. The program translation method according to claim 1,
wherein said optimizing includes:
setting, based on the hint information, information relating to a set into which the pieces of data to be optimized are placed; and
outputting, as hint information, the placement information determined in said setting.

10. The program translation method according to claim 1,
wherein said optimizing includes setting, based on the hint information, information relating to a set into which the pieces of data to be optimized are placed, and
said setting includes determining, based on the hint information, that pieces of data allocated to a predetermined number or more of processors from among the pieces of data specified by the hint information are placed into a region in a main memory which is not allocated to the cache memory.

11. The program translation method according to claim 1,
wherein the hint information includes information indicating one of processors to which each subject to be executed is allocated, the subject including the at least one subject to be executed other than the subject to be executed which is associated with the source program to be translated, and
said optimizing includes setting, based on the hint information, information relating to a set into which the pieces of data to be optimized are placed.

12. The program translation method according to claim 1,
wherein said optimizing includes allocating, based on the hint information, the subject to be executed which is a subject to be translated to one of processors in which the subject is to be executed, and
said allocating includes allocating, based on the hint information, the subject to be executed to one of the processors in which the subject is to be executed, in order to prevent the pieces of data specified by the hint information from being placed into a same set in the cache memory and causing thrashing or in order to prevent the same pieces of data from being allocated separately to the processors.

13. The program translation method according to claim 1,
wherein said optimizing includes allocating, based on the hint information, the subject to be executed which is a subject to be translated to one of processors in which the subject is to be executed, and
said allocating includes allocating, based on the hint information, the subject to be executed to one of processors in which the subject is executed so that the equal number of pieces of data are mapped to respective sets in a local cache memory of each processor.

14. The program translation method according to claim 1,
wherein said optimizing includes:
allocating, based on the hint information, the subject to be executed which is a subject to be translated to one of processors in which the subject is to be executed; and
outputting, as hint information, information relating to the processor allocation for the subject to be executed determined in said allocating.

15. A program translation method for receiving at least one object file and translating the received object file into a machine language program, said method comprising:
receiving hint information for increasing an efficiency of executing the machine language program; and
translating, based on the hint information, the object file into the machine language program while optimizing the object file,
wherein the hint information includes information relating to at least one subject to be executed other than a subject to be executed which is associated with the object file to be translated, and
said optimizing includes determining, based on the hint information, actual placement addresses of respective pieces of data included in the object file to be optimized.

16. The program translation method according to claim 15,
wherein the hint information includes information indicating pieces of data to be optimized including the at least one subject to be executed other than the subject to be executed which is associated with the object file to be translated.

17. The program translation method according to claim 15,
wherein the hint information includes information relating to actual placement addresses of respective pieces of data to be optimized, the pieces of data including the at least one subject to be executed other than the subject to be executed which is associated with the object file to be translated.

18. The program translation method according to claim 15,
wherein the hint information includes information indicating one of sets in a cache memory into which the pieces of data to be optimized are placed, the pieces of data including the at least one subject to be executed other than the subject to be executed which is associated with the object file to be translated.

19. The program translation method according to claim 15,
wherein said determining includes determining, based on the hint information, the actual placement addresses of the respective pieces of data included in the object file to be optimized, in order to prevent the pieces of data from being placed in a same set in the cache memory and causing thrashing.

20. The program translation method according to claim 15,
wherein said determining includes determining, based on the hint information, a set in the cache memory into which the pieces of data to be optimized are placed and determining, based on the determined set, the actual placement addresses of the respective pieces of data included in the object file to be optimized.

21. The program translation method according to claim 15,
wherein said optimizing further includes outputting, as hint information, information relating to the actual placement addresses determined in said determining.

22. The program translation method according to claim 15,
wherein said determining includes determining, based on the hint information, the actual placement addresses of the respective pieces of data included in the object file to be optimized in order to prevent the pieces of data specified by the hint information from being placed in a same set in the cache memory and causing thrashing, or in order to prevent the same pieces of data from being allocated separately to the processors.

23. The program translation method according to claim 15,
wherein said determining includes determining, based on the hint information, the actual placement addresses of the respective pieces of data included in the object file to be optimized so that the equal number of pieces of data are mapped to respective sets in a local cache memory of each processor.

24. The program translation method according to claim 15,
wherein said determining includes determining, based on the hint information, the actual placement addresses of the respective pieces of data so that the pieces of data are to be allocated to a region in a main memory which is not allocated to a cache memory, the pieces of data being allocated to a predetermined number or more of processors from among the pieces of data included in the object file to be specified by the hint information and to be optimized.

25. The program translation method according to claim 15,
wherein said optimizing includes allocating, based on the hint information, the at least one subject to be executed to a processor in which the at least one subject is executed.

26. The program translation method according to claim 25,
wherein the hint information includes information indicating one of processors to which each subject to be executed is allocated, the subject including the at least one subject to be executed other than the subject to be executed which is associated with the object file to be translated.

27. The program translation method according to claim 25,
wherein said allocating includes, based on the hint information, the subject to be executed to one of processors in which the subject is executed, in order to prevent pieces of data specified by the hint information from being placed to a same set in the cache memory and causing thrashing or in order to prevent the same pieces of data from being allocated separately to the processors.

28. The program translation method according to claim 25,
wherein said allocating includes allocating, based on the hint information, the subject to be executed to one of processors in which the subject is executed, so that the equal number of pieces of data are mapped to respective sets of a local cache memory of each processor.

29. The program translation method according to claim 25,
wherein said optimizing further includes outputting, as hint information, information relating to the processor allocation for the subject to be executed determined in said allocating.

30. A program development system for developing a machine language program from a source program, said system comprising:
a compiler system;
a simulation apparatus which executes the machine language program generated by said compiler system and outputs an execution log; and
a profiling apparatus which analyzes the execution log outputted by said simulation apparatus and outputs an execution analysis result for an optimization to be performed in said compiler system,
wherein said compiler system is a compiler system for developing a machine language program from a source program, said system comprising:
a first program translation apparatus which translates a source program written in a high-level language into a first machine language program; and
a second program translation apparatus which receives at least one object file and translates the received object file into a second machine language program,
wherein said first program translation apparatus includes:
a parser unit operable to perform lexical analysis and syntactic analysis on the source program;
an intermediate code translation unit operable to translate the source program into intermediate codes based on results of the lexical and syntactic analyses;
a first hint information receiving unit operable to receive first hint information for increasing an efficiency of executing the first machine language program;
a first optimization unit operable to optimize the intermediate codes based on the first hint information; and
a first machine language program translation unit operable to translate the intermediate codes optimized by said first optimization unit into a first machine language program,
wherein the first hint information includes information relating to at least one subject to be executed other than a subject to be executed which is associated with the source program to be translated, and
said second program translation apparatus includes:
a second hint information receiving unit operable to receive second hint information for increasing an efficiency of executing the second machine language program;
a second optimization unit operable to translate, based on the second hint information, the optimized object file into the second language program while optimizing the object file,
wherein the second hint information includes information relating to at least one subject to be executed other than a subject to be executed which is associated with the at least one object file to be translated.

31. The program development system according to claim 30,
wherein the hint information includes hint information outputted by said compiler system.

32. The program development system according to claim 30,
wherein the hint information includes the execution analysis result outputted by said profiling apparatus.
